(19) United States
(12) Patent Application Publication
(10) Pub. No.: US 2018/0249693 A1
(43) Pub. Date: Sep. 6, 2018

(54) INTERCHANGEABLE FISHING GUIDE SYSTEM

(71) Applicant: Ihab Ayoub, San Antonio, TX (US)

(72) Inventor: Ihab Ayoub, San Antonio, TX (US)

(21) Appl. No.: 15/912,523

(22) Filed: Mar. 5, 2018

Related U.S. Application Data
(60) Provisional application No. 62/467,047, filed on Mar. 3, 2017.

(51) Int. Cl. A01K 87/04

(52) U.S. Cl. CPC A01K 87/04; F16B 17/00

(57) ABSTRACT

Convertible fishing rod guide configurations capable of selective connection and removal of desired guide arrangements. Such guide arrangements may include spinning, casting, trolling/roller guides and the like. The convertible fishing guides include a base portion for connecting to the fishing rod, and an upper portion for reversibly connecting a portion of a fishing guide such as a foot or specialized connection element.

### CROSS-REFERENCE TO RELATED APPLICATIONS

This application claims priority to co-pending Provisional Patent Application No. 62/467,047, filed Mar. 3, 2017, and hereby incorporated by reference.

### BACKGROUND

### Field

The technology relates generally to line guides for fishing rods.

### Background Art

There are generally two primary categories of recreational fishing rods and reels:

casting and spinning. Typically, spinning arrangements involve a spinning reel having a spool which sits a distance from the rod, and that is generally aligned with the longitudinal axis of the rod. Because of the distance between the spinning reel spool and the rod, guides for spinning rods will typically have a wider line opening, and will be offset a greater distance from the rod to more readily align with the displacement of the spool from the rod. During typical use, the spool of a spinning reel does not rotate during casting and retrieval of line, and typically only does so as part of a drag system which permits rotation to prevent line breakage under strain.

In contrast, casting arrangement typically involve a casting reel which sits much closer to the rod, and whose spool is typically aligned perpendicular to the longitudinal axis of the rod. Because of a shorter distance between a casting reel spool and the rod, the guide openings for a casting rod are typically also closer to the rod, and traditionally have a much smaller line opening than their spinning counterparts, due to the more controlled manner in which line exits the spool during casting. In use, the spool of a casting reel typically rotates to unwind line during casting, and rotates in the opposite direction to rewind line during retrieval.

Fishing line guides are utilized with both arrangements, with the primary differences in guides between different fishing arrangements (casting/boat reels vs. spinning reels) being the size of guide, and offset of the line passage from the rod. For instance, with spinning arrangements, guides typically comprise a guide ring set relatively distant from the rod, whilst in casting/boat rod arrangements, guides may comprise a ring or a roller guide assembly, with the line passage portion (whether ring or roller) generally closer to the rod (less offset). Regardless of guide selection, the guides are typically attached to the rod via a combination of glue to affix the guide to the rod, thread wrapping over the feet of the guide and resin coating over the thread wrapping.

Because the differences between spinning and casting reels typically require different configurations of line guides as previously described, the rod and reel components of the two systems are generally not interchangeable. Thus, a spinning reel typically requires a dedicated spinning rod, and a casting reel typically requires a dedicated casting rod, if optimal functionality is desired. Accordingly, a need exists for a fishing rod guide system capable of providing the capability to utilize both spinning and casting arrangements effectively, on the same rod.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

A fishing rod guide base member configured to operatively connect to various line guide members to permit easy interchangeability and replacement of fishing guides.

A fishing rod having at least one guide location that includes a base member configured to reversibly connect to a line guide member.

To accomplish the foregoing and related ends, the following description and any annexed drawings shall set forth certain illustrative aspects and implementations. These may represent but a few of the various ways in which one or more aspects may be employed. Other aspects, advantages, and novel features of the disclosure will become apparent from the following detailed description when considered in conjunction with the annexed drawings.

### BRIEF DESCRIPTION OF DRAWINGS

FIG. 1 shows an embodiment of a fishing rod guide configuration having a moveable sleeve.

FIG. 2 show an embodiment of a fishing rod guide configuration having a pair of hinged mating elements.

FIG. 3 shows an embodiment of a fishing rod guide configuration having a combination slot and hinged mating configuration.

FIGS. 4a-4b demonstrate the use of a tensioned slot configuration according to one embodiment of a convertible fishing rod guide.

FIG. 5 shows one embodiment of a frictional mating configuration for a convertible fishing rod guide member.

### DETAILED DESCRIPTION

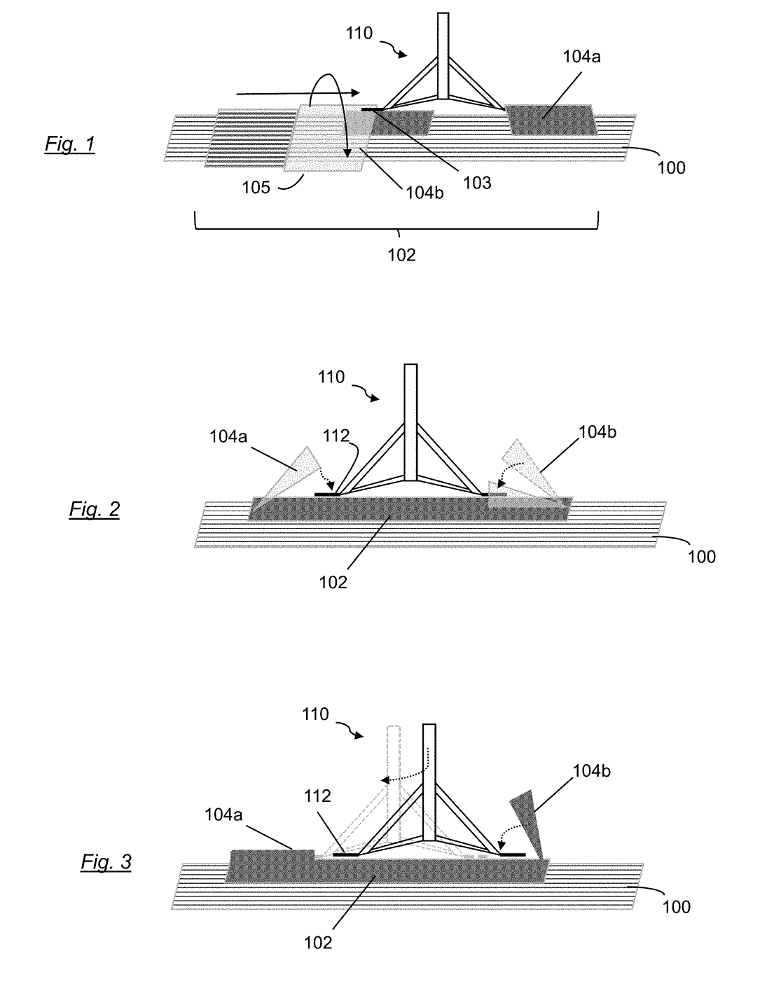

In one embodiment, a fishing rod comprises a tapered cylindrical member having a butt end proximal a real seating location, and a tip end. A plurality of fishing line guide locations are disposed along the length of the fishing rod between the butt end and the tip end. As shown in FIG. 1, at least one of the locations comprises a guide base member 102 operatively connected to the fishing rod 100, and at least one guide mating element 104a, 104b configured to operatively connect a line guide member 110 to the fishing rod 100.

In one embodiment, a base member 102 and a line guide member 110 are operatively connected to form a line guide assembly. The base member 102 is configured to attach to a fishing rod 100 and provide a connection for the line guide member 110. The line guide member 110 provides a passage for fishing line.

Individual base members will typically comprise a lower portion for operatively connecting to the rod 100 (e.g., comprising a rod connection element), and an upper portion for operatively connecting to a line guide member 110. The rod connection element of the base member 102 may be of any desired configuration, and will typically be configured to have a large and/or distributed contact area with the rod 100, to provide a more stable attachment of the base member 102 to the rod 100. The rod connection element may also be curved to conform to the curvature (along a circumference) of a rod, or include one or more legs configured for attachment to the rod. The rod connection element and any components thereof may also comprise a flexible material to conform to rod flexion during use, provide shock absorption, and to maintain a reliable connection to the rod.

In various embodiments, the line guide member 110 will comprise either a fixed line passage element such as a guide ring, which is typically elliptical in cross-section but may vary, or may comprise one or more roller members configured to rotate as line passes over or between the rollers. The line guide member will typically include a frame connecting the line passage element(s) to one or more feet (or other connecting configurations) for operatively connecting the line guide member. Feet, and similar extensions, may be configured as an extension of the frame. In certain embodiments, as will be described in further detail below, specialized connection configurations may replace the more traditional foot design, for operatively connecting to specialized configurations of base members.

When operatively connected to a fishing rod, a plurality of base members may be disposed in an aligned orientation at intervals along the length of the fishing rod. Such orientation is selected to align the base members along a predetermined fishing line path, typically extending in a substantially straight line between a reel seating area located near the base (or butt) of the rod, towards a distal tip of the rod.

In one embodiment, the rod connection element of the base member will comprise one or more feet to enable connection to the rod via traditional guide mounting techniques such as adhesives, thread wrapping, and/or glassing or other coatings. The upper portion of the base member, configured to reversibly connect a line guide member, may comprise various mating configurations, as will be described in further detail below.

Various embodiment of base members as described herein may be configured to operatively and reversibly connect to traditional line guides, or may be utilized with dedicated configurations of line guide members. Embodiments may therefore include mating elements configured to reversibly bind traditional line guide foot configurations, or may be configured to reversibly bind the novel line guide configurations described below, or a combination thereof.

In certain embodiments, the use of traditional line guides with the novel base members is contemplated, to provide the ability to utilize existing line guide configurations, possibly at the expense of a slightly increased combined height due to the inclusion of base member between the line guide and the rod. However, it is believed the benefits of having a versatile, interchangeable, line guide system will outweigh any nominal increase in overall height, particularly when a primary benefit to storage and transport of such systems includes a greatly reduced height upon removal of the line guide member for transport and storage.

The novel line guide members described herein will provide additional benefits, which may include a decreased combined height, because such dedicated line guide members need not be individually configured with integrated feet or other rod-connecting components, where that functionality may be provided by the base member. Additionally, dedicated line guide members for the configurations described herein may include a shortened frame because a portion of the combined height (base member+line guide member) will be provided by the base member.

Line guide members according to various embodiments will typically comprise a passage for fishing line (e.g., line ring or roller), a mating portion for reversibly connecting to the base member, and a frame connecting the line passage to the mating portion. The line passage may comprise various configurations, including elliptical (e.g., a line ring), and single or double roller configurations, as well as any other configurations known in the art.

The line passage, as well as the overall line guide member, may be of any desired size and shape. Such shapes and sizes may be selected to correlate to those of traditional line guide systems when the base member and line guide member are attached, thus providing a similar yet more functional alternative to traditional line guides. Generally, line guide members configured for spinning use will have an increased height (and often a wider diameter of at least certain guides) relative to those configured for casting use, when compared within the same weight classification.

The mating portion of the line guide member comprises one or more mating elements selected to reversibly connect with those of a corresponding base member. Base member mating elements may include, but are not limited to, screw-sleeve, clip-in, twist-on, clamp, tongue-in-groove, slot and rod, pinch-fit, slide-lock, combinations thereof, and others. Such mating elements may be configured to operatively connect to traditional line guide foot configurations, customized line guide mating elements and/or a combination thereof. For example, a clamping or screw sleeve configuration may be configured to operatively connect a traditional foot configuration of a line guide member.

Exemplary mating configurations, and their advantages will be discussed in detail below. Preferably, mating configurations will be selected to be operable without tools, while also providing a secure hold capable of withstanding impacts, flexion, and other forces that may be typically anticipated during use. Certain embodiments may also contemplate a degree of redundancy to ensure a secure connection. For example, a slotted element may be used in combination with a clamping element, to ensure that the line guide member is not displaced under typical use conditions, when connected to a base member.

One advantage of various embodiments described herein is the capability to easily detach one or more line guide members from the rod, thereby easing storage and transport. However, when reconnected, it is desirable that the connection be secure and preferably at least as capable and durable as traditional systems under contemplated use conditions.

Another significant advantage of embodiments herein is the capability to interchange the guides of a fishing rod to convert the fishing rod from a spinning rod to a casting rod, or the reverse. Accordingly, embodiments may include standardized mating elements to permit line guide members configured for spinning use, and line guide members configured for casting use, to be used with the same base member configurations. In one embodiment, different line classes or ranges of line classes will use a standardized mating element configuration to permit conversion between spinning and casting configurations, while also sized to ensure that the appropriate sizes of line guide members are utilized for a given line size classification.

Yet another significant advantage of embodiments herein is the capability to convert between traditional style line passages and roller-style line passages by simply substituting one type of line guide member for another. For example, if a user desires to cast with a particular rod, they may wish to use a circular line passage configuration, but should they wish to use the same rod for trolling they may to convert to a roller configuration by swapping a line guide ring member for a roller or double-roller style member, which typically provide a decreased friction on the line, but also a lessened ability to cast due to the narrower line passage typical to roller-style guides.

It may be preferable in various embodiments that the base member be configured to connect to the rod generally along only a portion of the circumference of the rod, without significantly wrapping around the rod. For example, the surface area(s) of the rod connection element(s) may be minimized. Such configurations advantageously have a reduced impact on rod flexion and reduced likelihood of being displaced during use or due to various impacts or other stressors. Similarly, in various embodiments it is preferable that the mating relationship between the base member and line guide member occur substantially on one side of the rod. That is, the line guide assembly including the base member and line guide member will be substantially disposed on only one side of the rod and generally add no greater bulk around the circumference of the rod than that added by traditional line guide connection systems. Reduced bulk at connection points will advantageously reduce interference with the rod's action in use.

In one embodiment, the line guide base member rod connecting element(s) or rod contact portion will be configured to contact no greater than one-half of the circumference of the rod, and more preferably no more than one-third of the circumference. Such configurations advantageously avoid adding bulk along the entire circumference of the rod (other than that minimal bulk provided by traditional thread wrapping or other binding techniques) thereby lessening interference with rod action and lessening overall circumference for ease of storage or transport.

Interchangeability between roller and casting guide configurations, and between casting and spinning guide configurations provides a great degree of versatility to any particular rod properly configured with embodiments of the base members. Such versatility results in significant costs savings because a single fishing rod can now replace up to three or more dedicated styles, with the only additional expense being the acquisition of the desired line guide member configurations. The capability to substitute for multiple rods is significantly advantageous during transport and travel, particularly because fishing rods are typically the most unwieldy elements of a fisherman's travel arsenal.

Another advantage of various embodiments is the capability to easily replace a damaged or defective line guide member, with an identical, similar, or different line guide member based on availability, cost and convenience. This is particularly advantageous when such damage occurs during use (i.e., in the field), and repair of tradition guides would require significant time to unwrap/rewrap, remove and reapply adhesive, and provide a drying time, whereas embodiments disclosed herein would be easily replaceable without significant detriment to fishing rod capability. Preferably removal and/or replacement of a line guide member requires no tools, and can be performed in a matter of seconds by the average user.

A significant benefit of various embodiments is a compact storage capability when the line guide members are removed. Accordingly, embodiments of the base members will preferably have a low profile relative to traditional guide heights for a given configuration. In one embodiment, the height of the base member (in a secured configuration) above the rod surface will preferably comprise no more than 30% of the overall combined height of base member and line guide when the two are combined, and more preferably no more than 20% of the overall combined height.

Because fishing rods are often classified by size or according to a particular fishing line strength for which they are configured, a compact height (e.g., low profile) will be relative to a traditional guide structure for a given classification. Preferably, the base members will have a height (from the bottom of the rod contact portion to the top of the guide mating portion) not substantially greater than what is required to include the desired mating elements and components for securing the base member to a rod.

In various embodiments, it is desirable to provide at least the same degree of flexibility, stability, and durability as that found in traditional line guide systems. Accordingly, techniques of securing the base members to the rod may mimic whatever techniques are preferred for securing traditional line guides, including the use of thread wrapping, adhesives, sealers, and the like. Generally, it will be desirable that the base members be permanently secured to the rods at desired locations (typically those selected for traditional line guide positioning) in a manner that ensures they will not be displaced or easily removable.

In certain embodiments, the base members may be configured as a single member (per line guide location) configured for line guide placement aligned with approximately the center thereof. Such a configuration advantageously equalizes the strain along the length of the member and provides sufficient space for placement of mating elements at both ends if desired, surrounding the line guide member. In single base member configurations, the base member may comprise a single or pair of line guide member mating elements.

In certain embodiments, the base members may be configured as a single member (per line guide location) configured for line guide placement at one end thereof. Such a configuration advantageously minimizing the length of the base member and will typically be utilized with line guide members having only a single mating element configuration (e.g., single-foot), or alternatively with a line guide member configured to operatively connect to the butt-side and tip-side of the base member with the line guide passage disposed above the body of the base member.

In various embodiments, base members may comprise a pair of spaced sub-members for use with a single line guide member. Such configurations may provide a decreased surface contact area with the rod (less interference with rod flexion) while also permitting greater versatility in mating element selection. For example a slot mating element for the first base sub-member, may be combined with a clamp mating element for the second base sub-member, to form a base member mating combination for a predetermined line guide member.

Base members may comprise double-bind or single-bind configurations, depending on whether an individual base member comprises a single mating configuration, or double mating configuration. For example, a single-bind configuration may be desired for use with line guide elements comprising only a single foot. For line guide elements comprising double foot configurations, either a double-bind base member may be utilized (offset pair of mating element configurations bound to the same base member substrate, e.g., dual-clip configuration of FIG. 2) or a pair of single bind configurations may be used, each disposed on a base sub-member to form a base member pairing, typically aligned such that the line guide member will be placed therebetween, as shown in the exemplary screw-sleeve configuration of FIG. 1.

In one embodiment, base members are configured to operatively connect to traditional line guide configurations. Such configurations typically include a frame, having either a line ring or one or more rollers for passage of line, and one to two feet for connecting to the rod (although some configurations may include up to four feet). Typically such feet extend away from the line passage and generally in the longitudinal direction of the rod. Base members may thus be configured to connect to a desired number of guide feet. Advantages of such configurations include the capability to utilize traditional and readily available line guide configurations, as well as the capability in some instances to alternate between single-foot and double-foot guide configurations, as will be further described in detail below.

In one embodiment, a base member is configured to operatively connect to at least one foot of a line guide member. The base member comprises at least one clamping element that may be reversibly clamped over the foot of the line guide member, thereby securing the line guide member to the rod. In dual-bind configurations, one set of mating elements of the base member may also advantageously be utilized with a single-foot guide, while the second set of mating elements is not utilized, thereby providing an increased versatility of line guide member selections.

In one embodiment, the base member is configured to operatively connect to at least one foot of a line guide member. The base member comprises at least one tubular slot for accepting the foot portion of the line guide member, which may be inserted into the slot. Slots may be sized to provide a secure frictional grip for a particular line guide foot size, thus ensuring that even single-foot configurations are securely retained. Alternatively, slots may be larger to accommodate a wider array of foot sizes and shapes, and will rely on the utilization of multiple slots to secure the line guide member to the base member and rod, or alternatively, secondary binding elements (e.g., clamps, screws and the like) to secure a foot within a generically-sized slot.

In one embodiment, multi-slot configurations will include at least two slots having openings towards the center of the base member such that a line guide member may be deformed (e.g., squeezed along its longitudinal axis) to allow placement of its feet into the opposing slots of the base member, and then when allowed to return to its uncompressed configuration, the feet will extend into the slots, thereby providing a secure connection between the line guide member and the base member.

In one embodiment, at least one slot of a base member may be rotatable such that when it is rotated from its (in-use) alignment with the longitudinal axis of the rod, it will more readily permit entry and exit of a line guide foot, and then when rotated back into alignment with the rod, one or more elements of the base member will cause the slot to be compressed, or will contact a portion of the foot disposed within the slot, to more securely hold the foot within the slot.

Slots of certain embodiments may have a circular, oval, rectangular, or any other cross-section deemed suitable for use with predetermined configurations of guide members. Slots may also taper, as is commonly done with guide feet, to more securely hold the feet, and to also provide for a more flush configuration of the end(s) of the base member with the rod. Slots may also include a linear slit, a notch, or other configuration of an opening in their upper wall, sufficient to permit some movement of the foot (e.g., sliding) in the longitudinal direction during flexion of the rod.

In one embodiment, screws or other suitable tightening elements may be utilized to secure a foot within a slot. Typically such elements will be moveable such that in a first position they press against the slot or foot to retain the connected relationship, and in a second position they do not press (or exert a decreased pressure) to permit movement of the foot into and out of the slot. Such tightening elements may also be used with clamping configurations to e.g., reversibly press a clamping element against a foot. Typically it will be preferable that such screws have a low profile to decrease the likelihood of entanglement with fishing line passing over the base member.

Referring again to FIG. 1, in one embodiment, an upper portion of the base member 102 will comprise one or more foot-receiving surfaces 103 for placement of one or more feet of a line guide 110, and one of the mating elements 104b comprises a tubular sleeve encircling both the rod 100 and a portion of the base member 102 will be tightened over the at least one guide foot, securing it above the foot receiving surface 103. The sleeve 104b and base member 102 may be threaded to permit tightening via screwing, or may include frictional contact surfaces so that the sleeve is wedged up over the portion of the base member and foot, thereby pinning the foot to the base member. Threading may be preferable as it is less likely to loosen under flexing load relative to a frictional fit. In either of the sliding or threading sleeve embodiments, one or more retention elements may be disposed on the inner surface of the sleeve, or on the outer surface of the base member, to retain the sleeve and base member in a secure configuration once the sleeve is moved into the locked position. A second foot of the line guide 110 may be secured within a mating element configured as a slot 104a, such that in use, one foot is placed into the slot and the second foot is lowered onto a foot receiving portion of the base member 102 over which the sleeve 104b may be moved to secure the second foot, and thereby the line guide 110 to the rod 100

In one embodiment, a platform of the base member configured to be the floor upon which a foot will rest is configured with a substantially flat surface, and feet of the line passage member may also be configured with a similarly flat bottom surface for maximal contact with the platform, advantageously providing a greater stability of the foot on the platform and more resistance to side forces on the line guide member. An additional advantage of such configurations includes the capability to utilize a uniform configuration of foot member for maximum lateral stability, while also having a base member configured with a rod-contact surface optimized for maximal rod contact (e.g., proper curvature). Thus while rod curvature will vary depending on rod circumference, base members may be configured to match the curvature for maximum contact, while line guide members may have a uniform foot configuration regardless of rod configuration. In certain embodiments, such a configuration provides the additional advantage of permitting the foot to slide longitudinally along the platform as the rod flexes and/or downward pressure is applied to the guide.

As shown in FIG. 2, in one embodiment, a base member mating element 104a, 104b comprises a hinged configuration capable of pivoting upwardly away from the base member 102 to permit placement of a foot 112 of a line guide member 110 onto a foot receiving portion of the base member 102, and then pivoting downwardly towards the base member 102 to secure the foot 112 to the foot receiving portion. Such hinges may be living hinges or any other configuration, and the pivoting mating element and/or other portions of the base member may be configured to lock the mating element at a lowered position, thereby maintaining a secure hold of the foot during use. For example, the mating element 104a, 104b may include flanged peripheral edges which wrap around, and frictionally secure beneath (or within) a portion of the base member 102 when lowered to a secured position. While the embodiment of FIG. 2 is shown with paired mating elements 104a, 104b, other embodiments may include only a single such mating element, configured to secure a single foot of the line guide 110.

The embodiment of FIG. 3 comprises a combination slot mating element 104a for sliding of a foot 112 of a line guide 110 thereinto, paired with a hinged mating element 104b configured to secure a second foot of the line guide 110 to the base member 102.

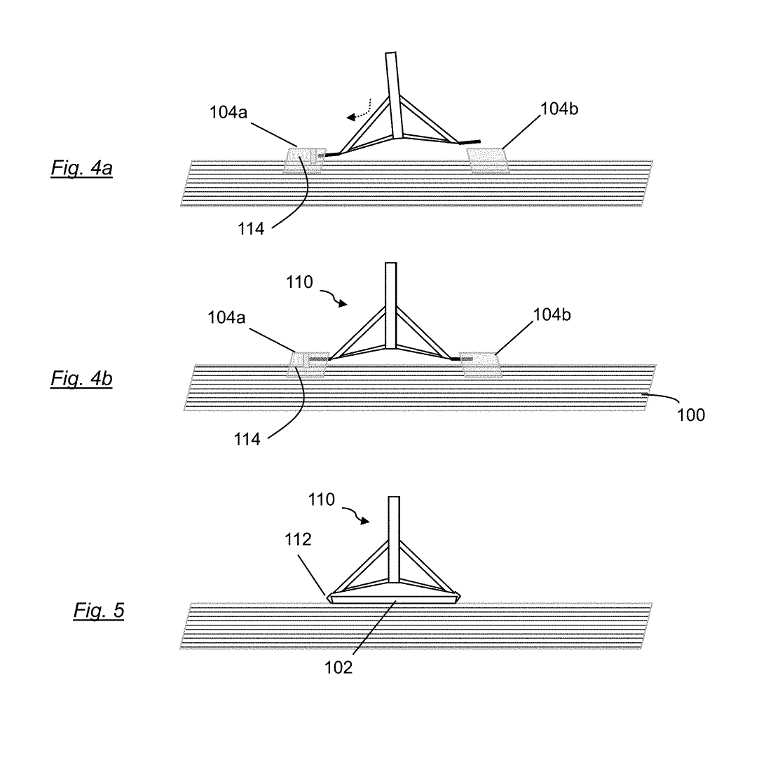

The embodiment of FIGS. 4a-4b comprises paired slot mating elements 104a, 104b, wherein at least one of the slots includes a spring-tensioner 114 disposed therein. The spring-tensioner is compressed as a first foot 112a of the line guide 110 is moved into the slot 104a, and biases the second foot 112b of the line guide 110 into the second slot 104b once aligned, thereby permitting easy mounting and removal of the line guide 110 to the base member 102, while securing the line guide 110 to the rod 100.

The embodiment of FIG. 5 comprises specialized feet 112 configured to frictionally retain the line guide 110 to the base member 102, which in this case comprises two tapered ends configured to retain the angled feet 112 of the line guide, when the line guide 110 is pressed onto the base member 102, causing the frame of the line guide 110 to flex until the feet 112 are slipped over the angled edges of the base member 102. While not visible in FIG. 5, as the base member 102 is shown in cross-section, the portion of the base member 102 configured to operatively connect to the feet 112 may comprise a slot having sidewalls to prevent undesirable lateral displacement of the feet 112 when connected.

Because “tip top” line guide configurations are often configured with only a single foot, embodiments of base members configured to be utilized at the rod tip may accordingly be configured to have a shorter length, preferably not extending significantly beyond the rod tip, and to operatively connect to only a single foot line guide configuration. Such embodiments will advantageously permit the changing of even the tip top line guides of a rod.

In one embodiment, a base member is configured to clamp to a rod and includes a line guide receiving groove in the rod contact portion thereof, such that when the base member is clamped to the rod, a line guide foot may be clamped between the base member and the rod, and substantially accommodated in the line guide receiving groove of the base member. Such a configuration advantageously provides for both ease of base member removal, repositioning and replacement as well as ease of line guide member removal, repositioning and replacement, utilizing the same attachment and detachment mechanism. Such “clamp-on” style base members may also be used individually, to e.g., connect a single-foot line guide to a rod, or in pair, e.g., to connect a double-foot line guide to a rod. In one embodiment, the rod may also be configured with retaining members at the guide locations, to prevent slippage of the base members when they are disposed within the guide locations.

In one embodiment, components of the mating interface (of the base and/or guide member) include flexion elements configured to provide a limited degree of movement to the guide member when attached to the base member. Such flexion elements may include elastomeric components, springs, and/or flexible configurations of components. Such capability permits the line guide member to deflect under load or during impact, without separating from the base member, or becoming damaged.

In one embodiment, the mating interface is configured to disconnect the line guide member from the base member when a predetermined force is applied to the line guide member, such predetermined force selected from those forces that occur during accidental impacts, but would not occur during normal use.

One embodiment comprises a fishing rod having a plurality of base members attached thereto, each of the base members comprising mating elements for reversibly connecting a line guide member. In one embodiment, a fishing rod comprising base members but no line guide members is provided. Such a configuration advantageously provides a lower cost alternative for a user who may already have compatible line guide members.

In one embodiment, a fishing rod having a plurality of base members, each of which includes mating elements, is combined with the same number of a selected style of line guide members, each of which has mating elements compatible with those of the base members, to form a kit. In one embodiment, a fishing rod having a plurality of base members, each of which comprises mating elements, is combined with two different styles of line guide members, each of which includes mating elements compatible with those of the base members, to form a kit wherein the fishing rod may be converted from a casting rod to a spinning rod, by substituting one style of line guide members for another.

Because the most significant line guide height differences between casting and spinning rod systems typically occur within the first few line guides (from the butt end), embodiments may include a fishing rod having integrated base members in place of the first few line guides, and traditional (i.e., permanently affixed) line guides for the remaining line guides. Thus, the first few line guides may be easily interchanged between casting and spinning configurations, and the remaining line guides may be suitable for both configurations. Such an embodiment advantageously provides for a simpler alternative for fishing rod conversion between casting and spinning configurations and a reduced cost, as a smaller number of alternative line guides would be needed in order to make the conversion.

Because guide sizes typically decrease from butt towards tip, those guides disposed towards the tip are typically smaller (i.e., more suited to compact storage and travel) and tend to be more similar between casting and spinning arrangements. Accordingly, a hybrid arrangement of fixed (tip-proximal) and interchangeable (butt-proximal) guides may provide an improved performance and versatility with a lessened complexity.

In one embodiment, a kit comprising a fishing rod having a select number of base members and a select number of permanently affixed traditional guides will also include removable line guide members compatible with the base members and configured to provide at least one line guide configuration selected from a spinning configuration and a casting configuration.

Connection of a base member to a rod may be of any type known in the art, including the use of adhesives and epoxies, wrapping, glassing, etc. In one embodiment, the rod-contact area of the base member will include a curvature selected to substantially match the curvature of the rod circumference at a predetermined base member mounting area. Such a configuration advantageously permits greater contact surface area between the base member and the rod.

In one embodiment, a base member may be configured to have multiple and separate contact areas with a rod. While surface contact area may be reduced in such configurations, this may be offset by a greater ability to tolerate rod flexion without becoming disconnected from the rod. In one embodiment a base member, or the rod connection elements thereof, may be configured to have a similar flexibility to the rod portions to which they are attached. For example, a base member disposed nearer a butt portion of a rod may be relatively inflexible because that portion of the rod generally flexes less under load, while a base member nearer the tip of the rod may comprise a more flexible material or configuration, as the rod tends to have a greater flex in areas near the tip, when under load.

Loading of a rod during use, as described herein, is generally defined as a force exerted upon a rod by line passing through the guides thereof and typically exiting the series of guides at an upper guide (furthest from the butt end), wherein the exiting line is pulled in a direction that differs from the longitudinal axis of the rod at rest. This will typically cause some degree of flexion of the rod in the direction from which the exiting line is being pulled. The term “pulling” as used in this description is merely a term of convenience, as rods may also be “loaded” in a manner that causes flexion in a multitude of ways including weight connected to a terminal end of the line, water friction upon line that has exited the rod guides, and various other means that are well understood in the art as capable of causing loading and flexion of a rod.

In one embodiment, base members may connected to the rod blank during formation of the blank. In one embodiment, such base members will comprise the same material(s) as the blank. In one embodiment, the rod-contact portions of the base members will be integrated into the rod blank during formation, and the guide mating portion of the base members will protrude beyond the surface of the rod blank. Such configurations may advantageously provide an even lower profile and increased security.

In one embodiment, the rod blank itself may be configured to incorporate mating elements for reversibly connecting a line guide member.

Dimensions, both absolute and relative, of the various embodiments described herein may vary. Because a compact base member height (when line guide member is removed) is a significant advantage of various embodiments, in certain embodiments, such base member height will be no greater than 60% of the traditional line guide height (as measured from rod contact to top of line guide) for that style and classification of rod, and more preferably less than 50%. Ideally, and particularly for spinning rods, the base member height will be no greater than 30% of the traditional guide height for such rod configurations. For certain embodiments, base member height is preferably no greater than 1 cm, more preferably less than 8 mm, and ideally less than 6 mm.

Proportionally, in certain embodiments it is preferred that base member height comprise no more than 30% of the overall height for spinning configurations, no more than 45% of the overall height for casting configurations, and no more than 60% of the overall height for roller configurations. For such purposes, height is measured from the rod surface to the top of the component being measured.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

Embodiments described herein may comprise any suitable material or combinations thereof. Because weight is often a consideration, lightweight materials common to the fishing arts may be preferable, including carbon fiber, aluminum, fiberglass and various plastics and resins. Such materials may also be selected to impart a desired degree of flexibility in order to minimize the likelihood of damage to or displacement of various components. Low friction materials or coatings may be preferable for line-contact portions of the various components.

In one embodiment, base members may be disposed in an offset orientation along the circumference of the rod, between the butt and tip of the rod, as may be desired in a “spiral” configuration of rod guides. While such configurations may comprise an offset distribution of base members along the circumference of the rod blank, individual base members will typically have a substantially matching alignment relative to the longitudinal axis of the rod, such that when a line guide member is attached to the base member, the line opening of the line guide member will be substantially aligned (with some small variation permissible for, e.g., spiral-style configurations) with a desired path of the fishing line between the reel seat portion of the rod, and the distal tip.

In one embodiment, a base member may be configured to include a frame portion and the line passage member may be configured to operatively connect to the frame portion of the base member, thus resulting in a less compact base member, but more compact line guide members. Line guide members may include roller, casting and spinning line passages, with a uniform connection element for connecting to the frame portion of the base member.

In one embodiment, portions of the base member(s), including a central region (between end-mounted mating elements) may be configured to be secured to the rod via wrapping or other external connection means. For example, an upper surface of a central region of the base member may comprise grooves for thread, tape, and other materials that may be used to bind the base member(s) to the rod.

Advantages of certain embodiments include the possibility to more specifically customize guide selection even within a particular spinning or casting configuration. For example, differently-sized reels of the same type (casting or spinning) may benefit from being utilized with line guides for that particular size. For example, a wide-spool casting reel may benefit from having a wider, low-profile guide, and a narrow-spool casting reel may benefit from being paired with a narrower guide. Additionally, more customized and specialized guide configurations may be introduced, in a manner that would advantageously permit a user to select between a conventional guide configuration, or a specialized configuration such as a rectangular guide, etc.

Advantages of various embodiments also include an easier capability to store multiple rods in small spaces, place rods into tighter areas (e.g., over the seats of a vehicle, into a shared rod tube, etc.), due to the capability to remove at least the larger guides (typically those closer to the butt end of the rod) for transport and storage.

Advantages of embodiments having base members that are aligned in a linear fashion along the length of the rod (similarly situated along the circumference) include reduced deflection of the line around the circumference of the rod.

Fishing rods utilized with various embodiments described herein may comprise any suitable material known in the art, including but not limited to, fiberglass, graphite/carbon fiber, bamboo, and combinations thereof. In certain embodiments it may be preferable that the fishing rod reel seat not comprise casting-specific components such as triggers and the like, which would lessen the versatility of the fishing rod for interchangeable use.

As used herein, the terms “foot” (singular) or “feet” (plural) generally describe an element having a generally thin, typically planar configuration and extending from the front and/or rear lower portion of a line passage member or base member and utilized to connect the member to a base member, or fishing rod, respectively.

The terms “comprising,” “including,” and “having,” as used in the claims and specification herein, indicate an open group that includes other elements or features not specified. The terms “a,” “an” and the singular forms of words include the plural form of the same words, and the terms mean that one or more of something is provided. The terms “at least one” and “one or more” are used interchangeably.

The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of an embodiment.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A fishing line guide base member for a fishing rod, comprising:
first and second ends separated by a central region;
a lower portion comprising at least one rod contact element for operatively connecting to the fishing rod; and
an upper portion comprising at least one line passage member mating element disposed proximal at least one of the first and second ends, the at least one line guide passage mating element configured to reversibly bind a predetermined line guide passage member such that a line guide passage of the line guide passage member shall be disposed above the central region of the base member when the line guide passage member and the base member are operatively connected in an operational configuration.

2. The fishing line guide base member of claim 1, wherein the at least one line guide passage member mating element comprises at least one selected from a clamp, a sleeve-lock, a slot, and a slideable member.

3. The fishing line guide base member of claim 2, further comprising a locking mechanism for locking the line guide passage member to the at least one line guide passage member mating element in a mated configuration.

4. The fishing line guide base member of claim 1, wherein the at least one line guide passage mating element comprises a slot generally parallel to the longitudinal axis of the fishing rod and comprising a longitudinal indentation formed in the body of the fishing line guide base member along the rod contact portion, the indentation selected to correspond to a predetermined foot configuration of the line guide passage member.

5. The fishing line guide base member of claim 1, wherein the upper portion comprises a raised longitudinal segment having tapering ends configured to frictionally retain a pair of feet of the line guide passage member.

6. The fishing rod guide base member of claim 1, wherein the lower portion comprises a resilient flexible material.

7. The fishing rod guide base member of claim 1, wherein the at least one mating element is moveable between a closed configuration to frictionally retain at least one foot of the fishing line guide member, and an open configuration wherein the at least one foot may be inserted or removed.

8. The fishing rod guide base member of claim 1, wherein the at least one mating element comprises a first mating element disposed proximal a first end, and a second mating element disposed proximal a second end, wherein the first mating element and the second mating element comprise two differing configurations.

9. The fishing rod guide base member of claim 8, wherein the two differing configurations are selected from clamp, slide-clamp, spring-loaded slot, pinch-fit, side-lock, and groove.

10. A fishing rod comprising:
a generally cylindrical longitudinal member having predetermined length and a first end comprising a butt and a second end comprising a tip;
a plurality of fishing line guide base members operatively connected at spaced locations along the length of the longitudinal member, wherein each of the fishing line guide base members comprises a lower surface configured to operatively connect to the longitudinal member at the spaced locations, and an upper surface comprising at least one mating element, the at least one mating element configured to reversibly connect a predetermined configuration of line guide.

11. The fishing rod of claim 10, wherein the plurality of fishing line guide base members occupy less than a totality of the fishing guide locations of the rod.

12. The fishing rod of claim 10, wherein the at least one mating element comprises a hinged foot lock.

13. The fishing rod of claim 10, wherein the at least one mating element comprises a combination of hinged foot lock and foot slot.

14. The fishing rod of claim 10, wherein each of the base members comprises a pair of inward-facing slots, at least one slot selected from each pair of slots further comprising a biasing mechanism configured to bias the line guide base member towards the opposing slot when the line guide base member is operatively connected to the pair of slots.

15. The fishing rod of claim 10, wherein each of the base members comprises at least two configurations of mating elements selected from clamp, slide-clamp, spring-loaded slot, pinch-fit, side-lock, and groove.

16. A fishing rod kit, comprising:
a fishing rod comprising a plurality of line guide locations, at least one of which includes a base member comprising mating elements for reversibly connecting to a line guide member; and
at least one line guide member configured to reversibly connect to the mating elements of the at least one base member.

17. The fishing rod kit of claim 13, wherein the at least one guide member comprises at least two different line guide types selected from casting, spinning, and roller configurations.

18. The fishing rod kit of claim 13, wherein the at least one guide member comprises at least two different configurations of mating elements selected from clamp, slide-clamp, spring-loaded slot, pinch-fit, side-lock, and groove.
